(19) United States
(12) Patent Application Publication
(10) Pub. No.: US 2015/0163469 A1
(43) Pub. Date: Jun. 11, 2015

(54) PROJECTION VIDEO DISPLAY APPARATUS

(71) Applicant: Yusaku Someya, Ibaraki (JP)

(72) Inventor: Yusaku Someya, Ibaraki (JP)

(73) Assignee: HITACHI MAXELL, LTD., Ibaraki-shi, Osaka (JP)

(21) Appl. No.: 14/356,841

(22) PCT Filed: Nov. 7, 2011
(86) PCT No.: PCT/JP2011/006178

§ 371 Date: Jun. 19, 2014

(51) Int. Cl. H04N 9/31; G03B 21/20

(52) U.S. Cl. CPC H04N 9/3144; G03B 21/2073; G03B 21/206

(57) ABSTRACT

A projection video display apparatus that maintains a highly reliable image quality while achieving high luminance of the apparatus is provided. The projection video display apparatus includes: a lens array for dividing light emitted from a light source into a plurality of luminous fluxes; a collecting lens for collecting light from the lens array; a color separating optical system for separating color light from the collecting lens; a video display element for forming an optical image from light separated by the color separating optical system; a projection lens for projecting the optical image; a cooling fan for cooling the video display element; a blower port arranged to supply air generated from the cooling fan from a lower part of the video display element; and a partition-wall duct arranged on a light-incident side of the video display element along a flow path of the air from the blower port.

### TECHNICAL FIELD

The present invention relates to a projection video display apparatus.

### BACKGROUND ART

Conventionally, a projection video display apparatus (such as a liquid crystal projector and a rear projection display apparatus) has been known, the projection video display apparatus modulating light intensity of light from a light source such as a high pressure mercury lamp in accordance with a video signal by a video display element such as a liquid crystal panel to form an optical image, and enlarging and projecting the formed optical image onto a screen or others. More particularly, in a projection video display apparatus compatible with color video, white light from a light source is separated into light with a plurality of colors (for example, three colors of R, G, and B) by a color separation optical system configured by color separation means (a dichroic mirror) or others, a light bulb unit (a unit including a video display element such as a liquid crystal panel and a polarizing plate for causing uniformed polarization light) corresponding to each chromatic light is irradiated with the light to form an optical image of the chromatic light, and the optical image of each chromatic light is synthesized by a color synthesizing prism and is projected by a projection lens.

In recent years, the density of light that passes through the video display element and the polarizing plate also increases as the apparatus increases in luminance, and therefore, it is becoming important to improve the cooling performance of the video display element and the polarizing plate. For the above-described issue, an invention relating to a liquid crystal projector having excellent cooling performance of a liquid crystal panel is disclosed (see Patent Document 1).

### PRIOR ART DOCUMENT

### Patent Document

Patent Document 1: Japanese Patent Application Laid-Open Publication No. 2009-145448

### DISCLOSURE OF THE INVENTION

### Problems to be Solved by the Invention

The Patent Document 1 describes such a configuration that a position between liquid crystal panels corresponding to colors R, G, and B arranged on three surfaces of a color synthesizing prism and a blower port for sending cooling air from a sirocco fan arranged below each of the liquid crystal panels is accurately determined. However, even if the blower port arranged below the liquid crystal panel can be accurately arranged at the center of the panel, the panel may not be sufficiently effectively cooled due to a pressure loss caused by the entering of the air into an adjacent light path of a multicolored panel because the cooling air is diffused also rightward and leftward during passing through the liquid crystal panel to an upper part of its effective optical area, or dust may be unevenly adhered to the panel, resulting in a deteriorated image quality because the cooling air is not evenly blown to the effective optical area of the light bulb unit.

Accordingly, a preferred aim of the present invention is to provide a projection video display apparatus that maintains a highly reliable image quality while increasing luminance of the apparatus.

### Means for Solving the Problems

In order to solve the above-described issue, one desirable aspect of the present invention is as follows. The projection video display apparatus includes: a lens array for dividing light emitted from a light source into a plurality of luminous fluxes; a collecting lens for collecting light from the lens array; a color separating optical system for separating color light from the collecting lens; a video display element for forming an optical image from the light separated by the color separating optical system; a projection lens for projecting the optical image; a cooling fan for cooling the video display element; a blower port arranged to supply air generated from the cooling fan from a lower part of the video display element; and a partition-wall duct arranged on a light-incident side of the video display element along a flow path of the air from the blower port.

### Effects of the Invention

According to the present invention, there can be provided a projection video display apparatus that maintains a highly reliable image quality while increasing luminance of the apparatus can be provided.

BRIEF DESCRIPTIONS OF THE DRAWINGS

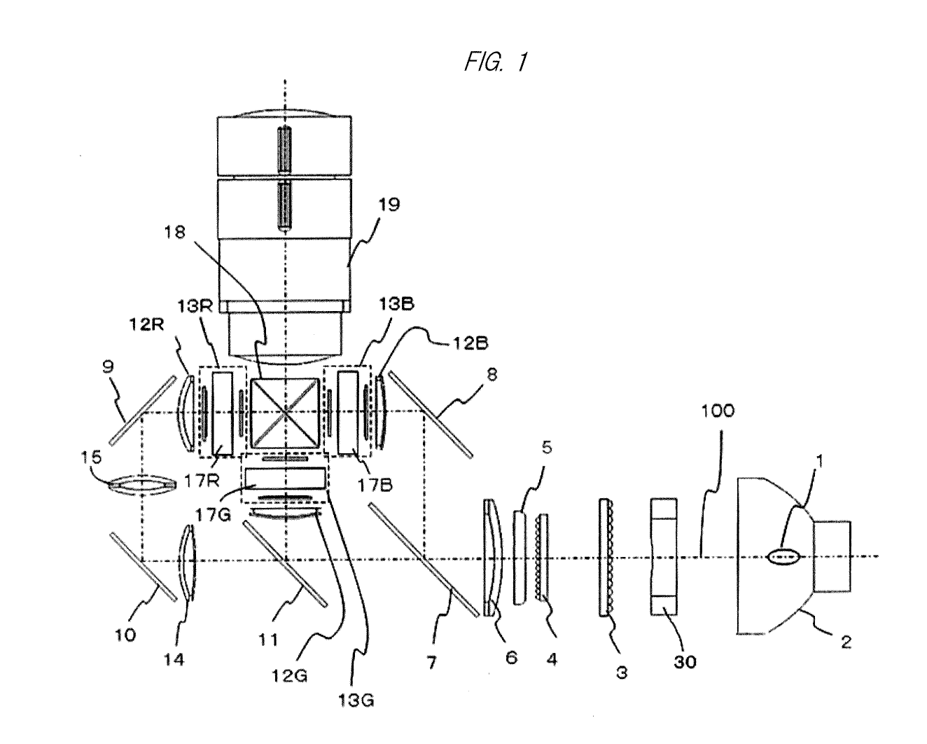

FIG. 1 is a diagram illustrating an optical system of a projection video display apparatus;

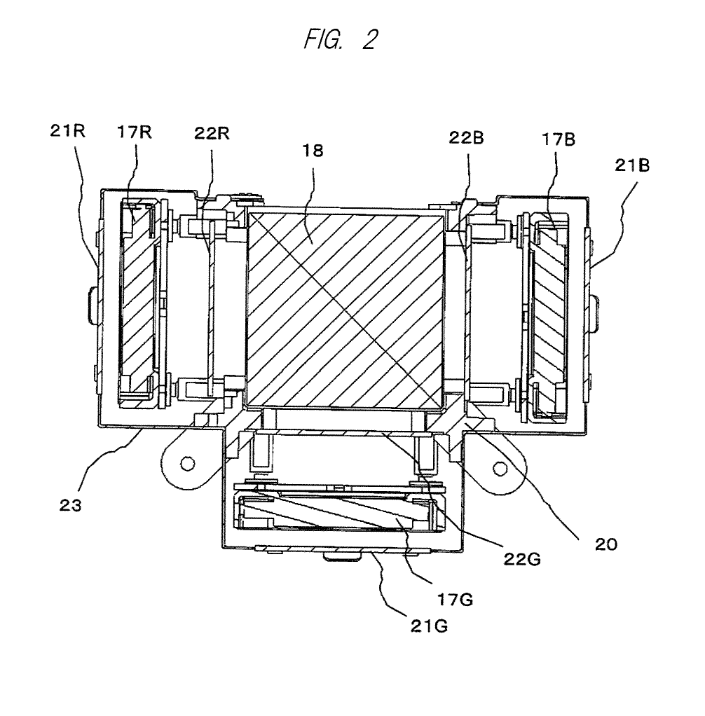

FIG. 2 is a top cross-sectional view of a light bulb unit;

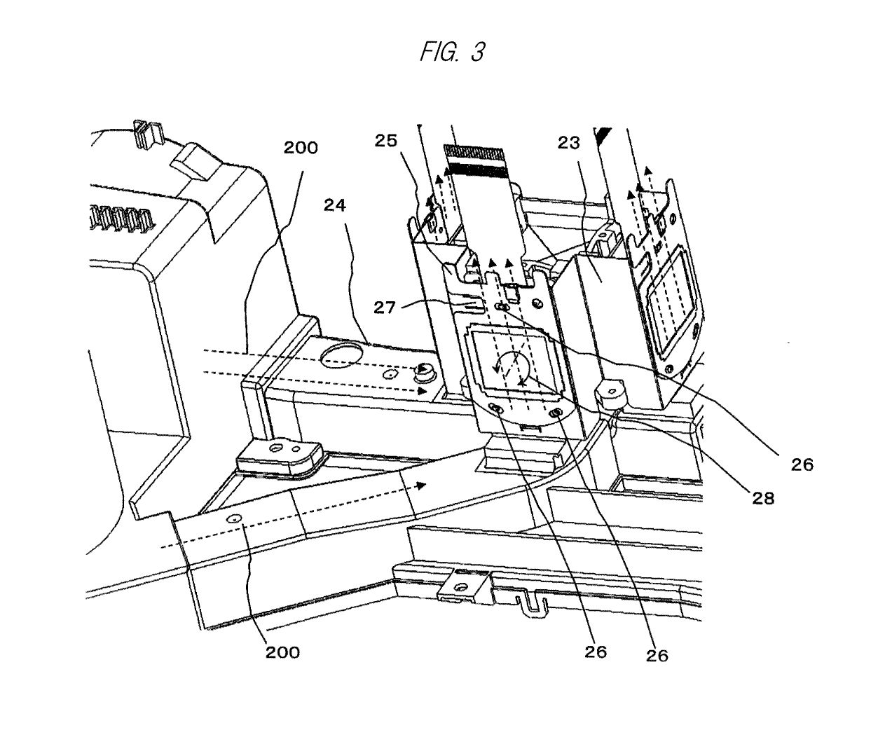

FIG. 3 is a perspective view of a light bulb unit and a cooling duct; and

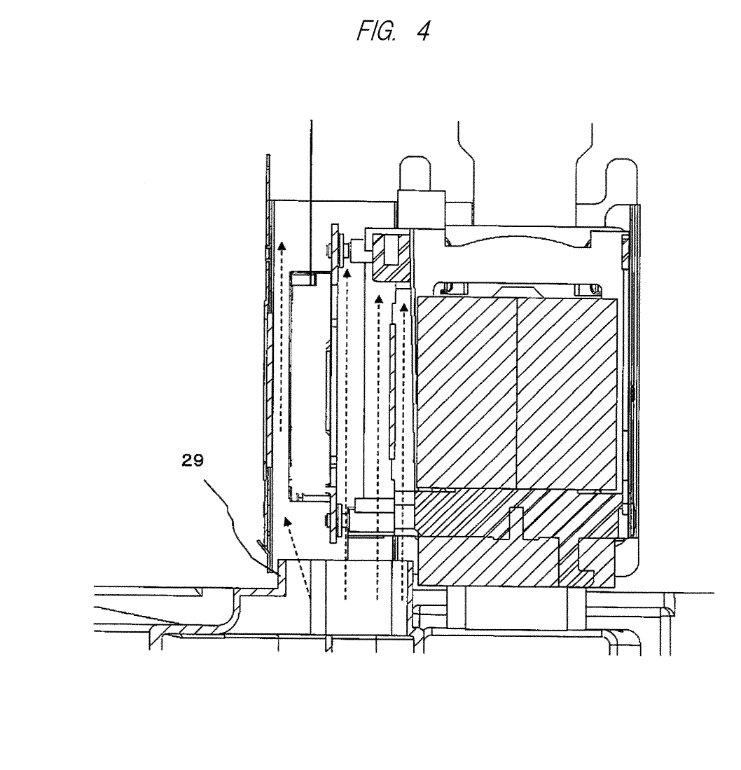

FIG. 4 is a side cross-sectional view of a light bulb unit and a cooling duct.

### BEST MODE FOR CARRYING OUT THE INVENTION

Hereinafter, an embodiment will be described below with reference to the drawings. Note that components with indexes “R (red)”, “G (green)”, and “B (blue)” denoted after the respective reference symbols are required to be distinguished by a plurality of optical paths separated depending on the colors. Also, the indexes are omitted unless any problem is particularly found in the explanation.

FIG. 1 illustrates an optical system of a projection video display apparatus.

A numerical symbol 1 is a light source which is a white lamp such as an extra high-pressure mercury lamp, a metal halide lamp, a xenon lamp, a mercury xenon lamp, or a halogen lamp. The light source 1 includes at least one reflector 2 having a circular or polygonal emission opening. The light emitted from the light source 1 is directed toward a projection lens 19 after passing through light bulb units 13R, 13G, and 13B each including a video display element and a polarizing plate, and is projected onto a screen. The light radiated from the lamp of the light source 1 has an optical axis 100, and is reflected on a parabolic reflector 2 and passes through an afocal lens 30 to be parallel light, and enters into a first lens array 3. Note that a configuration including the light source 1 and the reflector 2 is referred to as a light source unit.

The first lens array 3 is formed of a plurality of rectangular lens cell areas arranged in a matrix shape, and divides the incident light in each of the lens cell areas into a plurality of lights, and efficiently guides the lights to pass through a second lens array 4 and a polarization converting element (PBS) 5. That is, the first lens array 3 is designed so that the light source 1 and each of the lens cell areas of the second lens array 4 have a relation (a conjugate relation) between an object and an image. Also, the first lens array 3 and a video display element 17 (such as a liquid crystal panel) are designed to have the conjugate relation.

The second lens array 4 including the plurality of rectangular lens cell areas arranged in the matrix shape projects a shape of the lens cell area of the first lens array 3, corresponding to each of the lens cell areas forming the lens cell array 4, onto the video display element 17 in the light bulb unit 13. The polarization conversion element 5 makes the light from the second lens array 4 uniform in a predetermined polarization direction.

And, the projection images in the respective lens cell areas of the first lens array 3 are superimposed on the video display element 17 by a collecting lens 6, a condenser lens 12, a first relay lens 14, a second relay lens 15, and others. In this manner, illumination of illumination distribution having uniformity of an acceptable level in view of practice is possible.

A dichroic mirror 7 reflects the B light (light in a blue band) of the lights that have passed through the collecting lens 6, but transmits the G light (light in a green band) and the R right (light in a red band) thereof, so that the lights are separated into lights of two colors. Also, a dichroic mirror 11 reflects the G light of the lights of the two colors, but transmits the R light thereof, so that the G light and the R right are separated from each other.

Note that a method of separating the lights is not limited to this. For example, the dichroic mirror 7 may reflect the R light but transmit the G light and the B light, or may reflect the G light but transmit the R light and the B light.

In a configuration illustrated in FIG. 1, the B light is reflected by the dichroic mirror 7, and then, is reflected by a reflecting mirror 8, is transmitted through the condenser lens 12B and the light bulb unit 13B used for the B light, and enters a color synthesizing prism 18. Also, the G light is reflected by the dichroic mirror 11, and then, is transmitted through the condenser lens 12G and the light bulb unit 13G used for the G light, and enters the color synthesizing prism 18. Further, the R light is collected by the first relay lens 14, is reflected by a reflecting mirror 10, is further collected by the second relay lens 15, is reflected by a reflecting mirror 9, and then, is further collected by the condenser lens 12R (the third relay lens), is transmitted through the light bulb unit 13R used for the R light, and enters the color synthesizing prism 18.

An optical system from the passage of the entering light from the first lens array 3 through the condenser lens 12 to the entering of the light into the light bulb unit 13 is collectively referred to as a color separating optical system.

An optical image generated by performing optical intensity modulation in response to a video signal by the video display element 17 is synthesized as a color video by the color synthesizing prism 18, and then, the image passes through the projection lens 19 such as a zoom lens, and is enlarged and projected onto the screen.

When the light bulb unit 13 is irradiated with the light from the light source 1, the video display element 17 and a polarization absorbing element or a polarization reflecting element such as a polarizing plate are heated. The temperature is increased when this state is maintained so as to adversely affect the image display, and therefore, a cooling fan such as a sirocco fan, an axial flow fan, or a centrifugal fan is arranged so as to introduce outside air and so as to supply cooling air 200 to the light bulb unit 13 of each color to suppress the temperature increase.

FIG. 2 is a top cross-sectional view of the light bulb unit 13. This unit has a configuration in which air having a high flow rate maintained in the effective optical area surface of the video display element can linearly and uniformly supplied.

The light bulb unit 13 is configured by video display elements 17R, 17G, and 17B, light-incident polarizing plates 21R, 21G, and 21B arranged on a light-incident side of the video display elements 17R, 17G, and 17B, and light-emission polarizing plates 22R, 22G, and 22B arranged on a light-emission side of the video display elements 17R, 17G, and 17B. At the center of the light bulb unit 13, a color synthesizing prism 18 for synthesizing the optically-modulated three color lights and a prism holder 20 for holding the color synthesizing prism 18 are arranged. Also, the prism holder 20 is attached with a partition-wall duct 23 for achieving closed spaces that are independent from each other of R, G, and B in an optical path from the light-incident polarizing plate 21 to the color synthesizing prism 18. Although an opening for making the light enter the video display element 17 is required for the partition-wall duct 23, the closed spaces are achieved by a configuration in which the light-incident polarizing plate 21 is attached to the partition-wall duct 23 directly or via an indirect member so as to close the opening. In the present embodiment, a sheet metal component is assumed as the partition-wall duct 23. However, the partition-wall duct 23 may have a similar configuration using a resin molded product or sheet material.

FIG. 3 is a perspective view of the light bulb unit 13 and a cooling duct 24. In order to cool the light bulb units 13R, 13G, and 13B, the cooling duct 24 is arranged, the cooling duct being used for blowing the outside air introduced by using the cooling fan such as the sirocco fan, the axial flow fan, or the centrifugal fan from lower parts of the light bulb units 13R, 13G, and 13B. The cooling air supplied from the cooling duct 24 is linearly supplied by the partition-wall duct 23 as being uniformed and maintaining the high flow rate in the effective optical area surface of the video display element 17 without being diffused to the optical path of the other color. Since each of the optical paths is closed by the partition-wall duct 23, not only the cooling air but also excessive outside light emitted out of the effective optical area of the liquid crystal display element can be suppressed without being diffused, so that the deterioration in the image quality or others caused by taking unnecessary light into the projection lens can be also suppressed.

The partition-wall duct 23 holds the light-incident polarizing plate 21 via a rotation adjusting member 25. Also, the partition-wall duct 23 includes: a pin 26 (at three points inside a circumference centered on an optical axis) for determining a rotation center of the rotation adjusting member 25; and a spring 27 for holding the rotation adjusting member 25. The light-incident polarizing plate 21 rotates in a direction indicated by an arrow 28. That is, the partition-wall duct 23 has a function of determining the rotation center of the rotation adjusting member 25 and a function of holding the rotation adjusting member 25.

A conventional configuration is a configuration in which the rotation adjusting member is held in the color separating optical system. However, a configuration of the present embodiment is a configuration in which the rotation adjusting member is held in the partition-wall duct, and therefore, contrast can be adjusted by rotating the light-incident polarizing plate while achieving the closed spaces.

FIG. 4 is a side cross-sectional view of the light bulb unit 13 and the cooling duct 24. It is desired to arrange the blower port 29 included in the cooling duct 24 so as to be a relation between a socket and a spigot (“inrou relation” in Japanese) inside the partition-wall duct 23. By such a configuration, the diffusion of the cooling air emitted from the blower port 29 can be suppressed as much as possible.

Note that similar closed spaces may be formed by forming the prism holder 20 in such a similar shape or forming the cooling duct 24 in such a similar shape instead of the partition-wall duct 23.

The above-described embodiment includes a partition-wall structure in which the panels of the colors are independent from each other so that the air does not flow around the liquid crystal panels of the other colors by arranging the partition-wall duct having the socket-and-spigot relation with respect to the blower port below the liquid crystal panel of each of the colors, and therefore, the cooling air supplied from the blower port passes to an upper part of the liquid crystal panel as being uniformed and being linearly without being diffused toward the liquid crystal panels of the other colors. Therefore, the flow rate on the effective optical area surface of the liquid crystal panel can be increased, and unevenness in the flow rate (unevenness in cooling) can be uniformed, and thus, an apparatus having excellent reliability and cooling performance can be provided. Moreover, since the partition-wall duct also has a function of holding the polarizing plate arranged on the light-incident side of the liquid crystal panel, the degree of the closing is not deteriorated while bringing the necessary light to the liquid crystal panel. That is, unnecessary stray light can also be cut.

### SYMBOL EXPLANATION

1 . . . light source, 2 . . . reflector, 3 . . . first lens array, 4 . . . second lens array, 5 . . . polarization converting element (PBS), 6 . . . collecting lens, 7 . . . dichroic mirror, 8, 9, and 10 . . . reflecting mirror, dichroic mirror, 12 . . . condenser lens, 13 . . . light bulb unit, 14 . . . first relay lens, 15 . . . second relay lens, 17 . . . video display element, 18 . . . color synthesizing prism, 19 . . . projection lens, 20 . . . prism holder, 21 . . . light-incident polarizing plate, 22 . . . light-emission polarizing plate, 23 . . . partition-wall duct, 24 . . . cooling duct, 25 . . . rotation adjusting member, 26 . . . rotation adjusting pin, 27 . . . spring, 28 . . . rotation direction of light-incident polarizing plate, 29 . . . blower, 30 . . . afocal lens, 100 . . . optical axis, 200 . . . cooling air

1. A projection video display apparatus comprising:
a lens array for dividing light emitted from a light source into a plurality of luminous fluxes;
a collecting lens for collecting light from the lens array;
a color separating optical system for separating color light from the collecting lens;
a video display element for forming an optical image from light separated by the color separating optical system;
a projection lens for projecting the optical image;
a cooling fan for cooling the video display element;
a blower port arranged to supply air generated from the cooling fan from a lower part of the video display element; and
a partition-wall duct arranged on a light-incident side of the video display element along a flow path of the air from the blower port.

2. The projection video display apparatus according to claim 1, comprising a polarizing plate arranged on the light-incident side of the video display element,
wherein the polarizing plate is attached to the partition-wall duct so as to close an opening for making the light enter the video display element.

3. The projection video display apparatus according to claim 1,
wherein the partition-wall duct and the blower port are arranged in a socket-and-spigot relation.

4. The projection video display apparatus according to claim 2,
wherein the polarizing plate is attached to the partition-wall duct through a rotation adjusting member, and
the partition-wall duct has a function of determining rotation center of the rotation adjusting member and a function of holding the rotation adjusting member.
